(19) United States
(12) Patent Application Publication
(10) Pub. No.: US 2007/0183409 A1
(43) Pub. Date: Aug. 9, 2007

(54) Facsimile servicing via peer-to-peer internet protocol telephony network

(75) Inventor: James D. Bennet, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/641,196

(22) Filed: Dec. 18, 2006

Related U.S. Application Data
(63) Continuation-in-part of application No. 11/348,962, filed on Feb. 7, 2006.
(63) Continuation-in-part of application No. 11/348,814, filed on Feb. 7, 2006.
Application No. 11/348,814 is a continuation-in-part of application No. 11/348,743, filed on Feb. 7, 2006.
(63) Continuation-in-part of application No. 11/448,458, filed on Jun. 6, 2006.
Application No. 11/448,458 is a continuation-in-part of application No. 11/348,962, filed on Feb. 7, 2006.

(51) Int. Cl. H04L 12/66; H04L 12/56

(52) U.S. Cl. 370/352; 370/401

(57) ABSTRACT

A telephony bridging device operates within infrastructure that includes a packet data network (Internet) and the Public Switched Telephone Network (PSTN) telephony network and supports a coupled POTS telephony device. The telephony bridging device is operable to bridge calls between every two of the POTS telephony device, the PSTN network, and the packet data network (Internet). The telephony bridging device selectively bridges incoming calls to the POTS telephony device, to remote PSTN terminals, and to remote VoIP terminals based upon telephony bridging instructions. These telephony bridging instructions may be stored locally or remotely.

### CROSS REFERENCES TO RELATED APPLICATIONS

This application is a continuation-in-part of the following co-pending applications:

1. Utility application Ser. No. 11/348,962, filed on Feb. 7, 2006, and entitled “TELEPHONE SUPPORTING BRIDGING BETWEEN A PACKET SWITCHED NETWORK AND THE PUBLIC SWITCHED TELEPHONE NETWORK” (BP5090);

2. Utility application Ser. No. 11/348,814, filed on Feb. 7, 2006, and entitled “COMPUTING DEVICE SUPPORTING BRIDGING BETWEEN A PACKET SWITCHED NETWORK AND THE PUBLIC SWITCHED TELEPHONE NETWORK” (BP5092);

3. Utility application Ser. No. 11/348,743, filed on Feb. 7, 2006, and entitled “SET TOP BOX SUPPORTING BRIDGING BETWEEN A PACKET SWITCHED NETWORK AND THE PUBLIC SWITCHED TELEPHONE NETWORK” (BP5091); and

4. Utility application Ser. No. 11/448,458, filed on Jun. 6, 2006, and entitled “TELEPHONY BRIDGING DEVICE SUPPORTING MULTIPLE PATHWAY TELEPHONY BRIDGING” (BP5272).

### BACKGROUND OF THE INVENTION

1. Technical Field of the Invention

This invention relates generally to communication systems and more particularly to Voice over Internet Protocol (VoIP) telephony and to Public Switched Telephone Network (PSTN) telephony.

2. Description of Related Art

Voice telephony has been known for many years. Initially, voice telephony was supported by dedicated conductors between telephones. Then, voice telephony was enabled by operators manually switching connectors to create and tear down circuits between telephones. As technology advanced, mechanical components performed the switching operations to create and tear down circuits between telephones. With advancing technology, computers and semiconductor components replaced the mechanical components to perform circuit switching duties. Networks created using this circuit-switched technology are generally known as the Public Switched Telephone Network (PSTN). Generally, the PSTN provides a circuit-switched, time-divided connection between telephones.

Packet data communications, such as those supported by the Internet, differ from circuit-switched communications. With packet data communications, a source device forms a data packet, transmits the data packet to a packet data network, and based upon a destination address, e.g., Internet Protocol (IP) address of the data packet, the packet data network passes the data packet to a destination device. As the Internet and other packet data networks grew in popularity, packet switched voice telephony was developed. One common type of packet switched voice telephony is Voice over Internet Protocol (VoIP) telephony. When VoIP telephony was first introduced, the data packet transmission latency of the Internet and of other servicing networks caused the quality of VoIP telephony to be significantly worse than that of PSTN telephony. Over time, packet data transmission latency of the Internet and of other servicing packet data networks has decreased. Now, VoIP telephony provides service quality equal to or better than VoIP telephony in many cases.

Recently developed VoIP telephony applications enable computer users to establish non-toll VoIP telephone calls across the Internet. Compared to PSTN telephony VoIP telephony of this type is significantly less expensive, particularly for overseas calls. However, only a limited number of people have a computer upon which this VoIP telephony application may be loaded and have Internet access of a quality that will support the VoIP telephony application.

In order to gain some advantages of VoIP telephony but still service consumers having PSTN telephones, VoIP telephony service providers typically deploy VoIP gateways. The VoIP gateways bridge communications between the PSTN (PSTN telephony call) and the Internet (VoIP telephony call). VoIP telephony service providers typically extract a toll for servicing a call via the VoIP gateway bridge, thus destroying in part the low cost attractiveness of VoIP telephony. Thus, a need exists for systems and methods of operations that overcome the shortcomings of these prior telephony systems.

### BRIEF SUMMARY OF THE INVENTION

The present invention is directed to apparatus and methods of operation that are further described in the following Brief Description of the Drawings, the Detailed Description of the Drawings, and the Claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a system diagram illustrating a plurality of telephony bridging devices construction according to the present invention and their interaction with a telephony infrastructure;

FIG. 2 is a system diagram illustrating a plurality of telephony bridging devices construction according to the present invention and their interaction with a telephony infrastructure;

FIG. 3 is a system diagram illustrating a telephony infrastructure that includes a telephony bridging device constructed and operating according to an embodiment of the present invention;

FIG. 4 is a system diagram illustrating a telephony infrastructure that includes a telephony bridging device constructed and operating according to an embodiment of the present invention;

FIG. 5 is a block diagram illustrating a telephony bridging device constructed according to an embodiment of the present invention;

FIG. 6 is a flow chart illustrating operation of a telephony bridging device according to an embodiment of the present invention;

FIG. 7 is a flow chart illustrating PSTN to VoIP bridging operations of a telephony bridging device in accordance with an embodiment of the present invention;

FIG. 8 is a flow chart illustrating VoIP to PSTN bridging operations of a telephony bridging device in accordance with an embodiment of the present invention;

FIG. 9 is a flow chart illustrating VoIP to VoIP bridging operations of a telephony bridging device in accordance with an embodiment of the present invention;

FIG. 10 is a flow chart illustrating bridging setup operations of a telephony bridging device in accordance with an embodiment of the present invention;

FIG. 11 is a flow chart illustrating tracking server setup/update operations in accordance with an embodiment of the present invention;

FIG. 12 is a flow chart illustrating tracking server access operations in accordance with an embodiment of the present invention;

FIG. 13 is a flow chart illustrating message server bridging operations in accordance with an embodiment of the present invention; and

FIG. 14 is a flow chart illustrating call setup operations in accordance with an embodiment of the present invention.

### DETAILED DESCRIPTION OF THE INVENTION

Telephony bridging devices 102 and 103 couple to the PSTN network 106 via wired and/or wireless connections. Thus, for example, each of telephony bridging device 102 and 103 includes a circuit switched interface that communicatively couples the telephony bridging device 102 or 103 to the PSTN network 106. The wired connections may be serviced via twisted copper pair wiring, fiber optic cabling, or another type of conductor.

Telephony bridging devices 102 and 103 also couple to packet data network 104 via wired and/or wired connections. Telephony bridging device 102 couples directly to the packet data network 104 via its packet switched interface. Such direct connection may be via a local area network, cable modem, satellite modem, digital subscriber line, fixed wireless access, wireless local area network (WLAN) access, metropolitan wireless area network access (YMAX), or another packet switched interface connection. The telephony bridging device 102 supports communication with personal computer 116 via personal computer interface, e.g., LAN connection, WLAN connection, USB connection, fire wire connection, or another data interface.

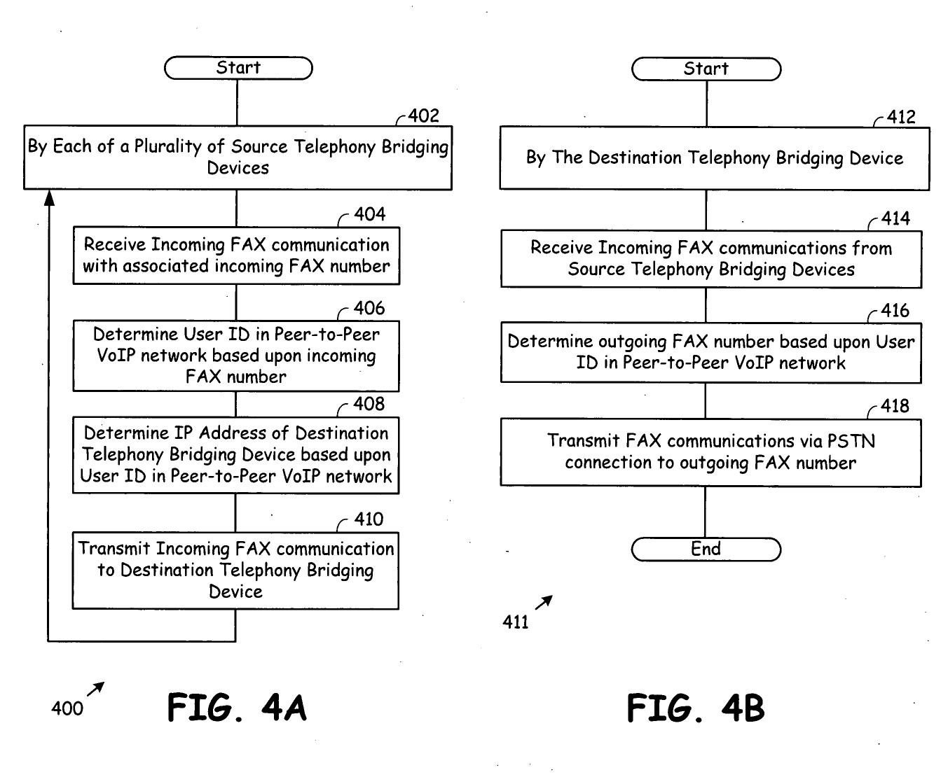

Telephony bridging device 103 couples to packet data network 104 via a personal computer 118. A packet data network interface of the telephony bridging device 103 includes a personal computer bus interface that supports packet switched communications between the telephony bridging device 103 and the personal computer 118. Personal computer 118 supports packet switched communication between the telephony bridging device 103 and the packet data network 104 via a packet data network interface of the personal computer 118. The telephony bridging device 103 may be formed within a housing so that the telephony bridging device 103 may fit within an expansion card opening of personal computer 118. Such housing may contain all or a substantial portion of the POTS driver circuitry of, the packet switched interface, the circuit switched interface, and the processing circuitry of telephony bridging device 103. The general structure of telephony bridging devices 102 and 103 will be described further with reference to FIG. 4.

Generally, each of the telephony bridging devices 102 and 103 has interfaces to its supported POTS telephony device(s), the packet switched network 104, and the PSTN network 106. According to a first aspect to the present invention, each of the telephony bridging devices 102 and 103 is operable to bridge calls between every two of its POTS driver circuitry, its circuit switched interface, and its packet switched interface. In particular, in a first operation, telephony bridging device 103 is operable to bridge calls between its POTS driver circuitry (that services POTS telephony device 108) and its packet switched interface circuitry (that couples to packet data network 104). Thus, with this first operation, the telephony bridging device 103 is operable to bridge calls between the POTS telephony device 108 and VoIP telephone 120, for example. Further, according to this first operation, the auxiliary bridging circuitry 103 is operable to bridge a call between the POTS telephony device 108 and personal computer 116 (having headset connected thereto). With a second operation, the telephony bridging device 103 is operable to bridge calls between its POTS driver circuitry and its circuit switched interface. With the second operation, the telephony bridging device 103 is operable to bridge calls between the serviced POTS telephony device 108 and a PSTN telephone 122, for example. Further, according to a third operation of the telephony bridging device 103, the telephony bridging device 103 is operable to bridge calls between its circuit switched interface and its packet switched interface. With this operation, the telephony bridging device 103 is operable to bridge a call between PSTN telephone 122 and VoIP telephone 120, for example. According to this third operation particularly, telephony bridging device 103 supports the interface to PSTN telephone 122 via its circuit switched interface and the VoIP telephone 120 via its packet switched interface.

According to another aspect of the present invention, the telephony bridging devices 102 and 103 perform call management operations. With these call management operations, telephony bridging device 102, for example, receives a PSTN call setup request from PSTN phone 122 relating to an incoming call via the PSTN network 106. In response to receipt of this PSTN call setup request, the telephony bridging device creates a VoIP call request based upon the PSTN call request. Then, the telephony bridging device 102 sends the VoIP call request to VoIP telephone 120 via the packet switched telephony network 104.

Likewise, the telephony bridging device 102 is operable to receive a VoIP call setup request relating to an incoming call via the packet switched telephony network 104 from VoIP telephone 120. In response thereto, the telephony bridging device 102 creates a PSTN call setup request based upon the VoIP call request. Then, the telephony bridging device 102 sends the PSTN call request via the PSTN network 106 to PSTN telephone 122. These operations may also be supported between other VoIP telephony devices such as personal computers 116 and 118. Other aspects and operations of the telephony bridging devices 102 and 103 and their interaction with the packet switched network 104 and the PSTN network 106 will be described further with reference to FIGS.

The wireless access point 304 supports WLAN and/or Wireless Personal Area Network (WPAN) communications. The WLAN communications may operate according to any of the IEEE 802.11 standards such as IEEE 802.11a, IEEE 802.11b, IEEE 802.11g, IEEE 802.11n, or another WLAN operating standard. WPAN operations may be according to the Bluetooth operating standard or the IEEE 802.15 operating standard, for example.

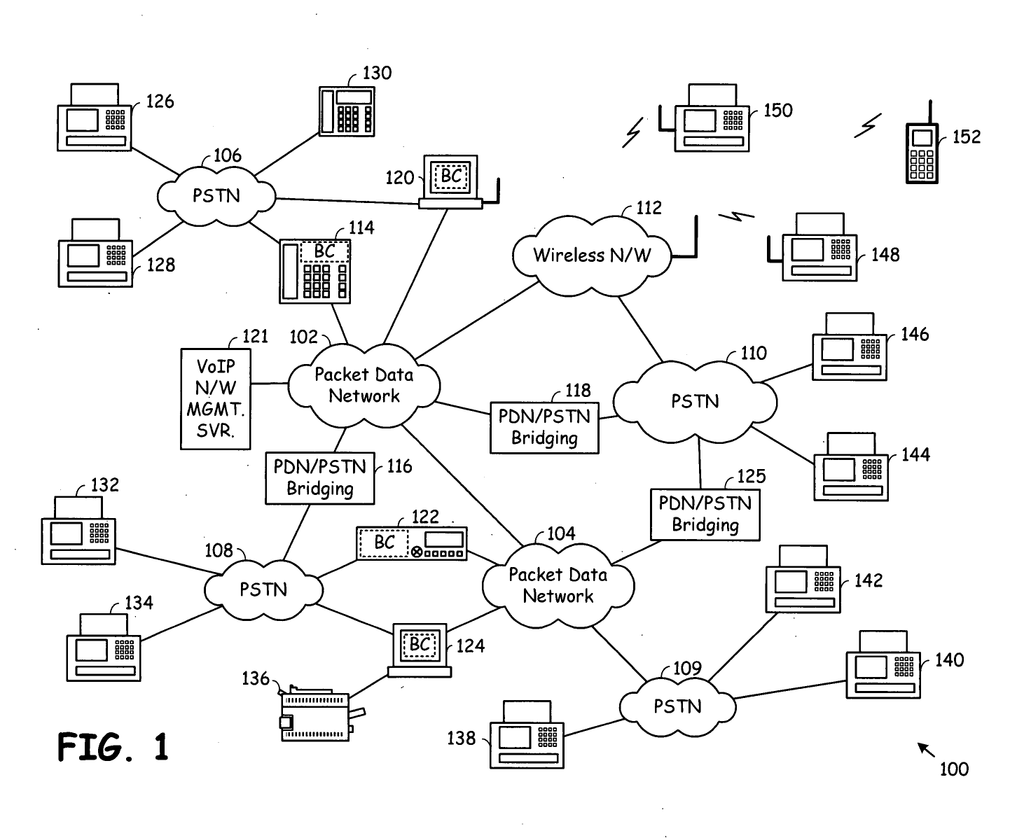

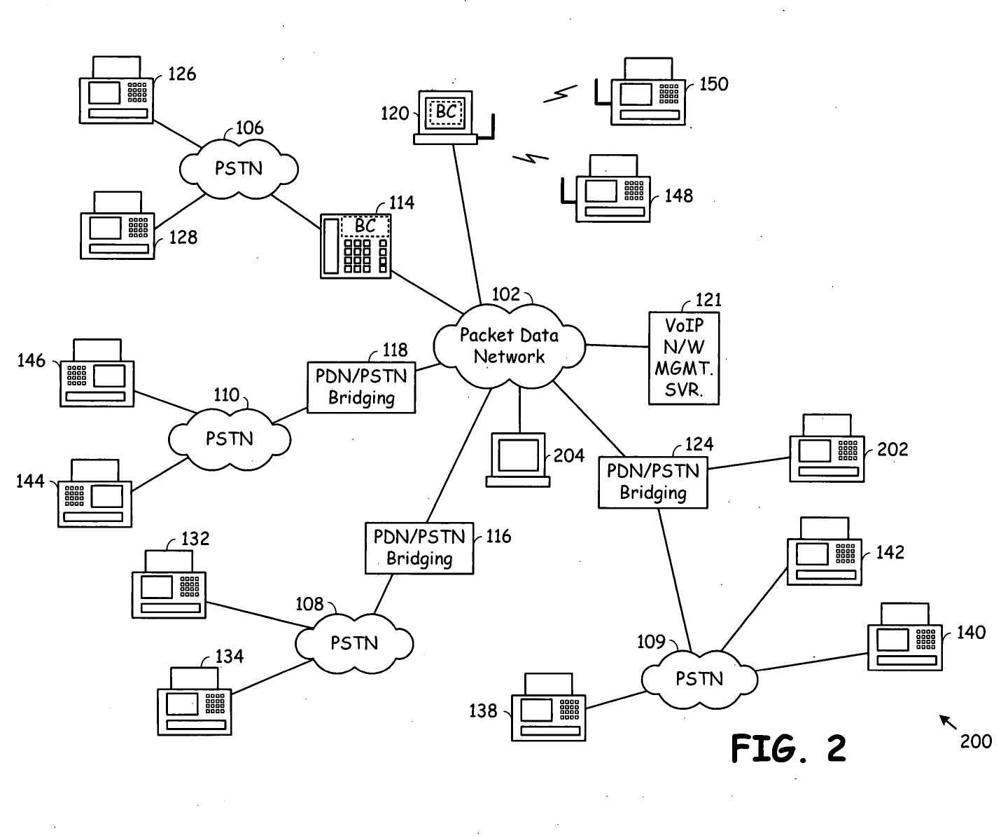

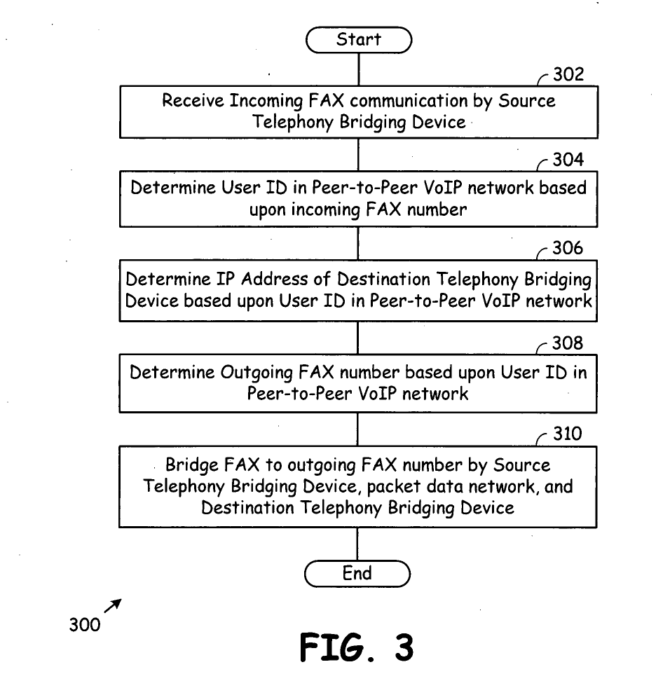

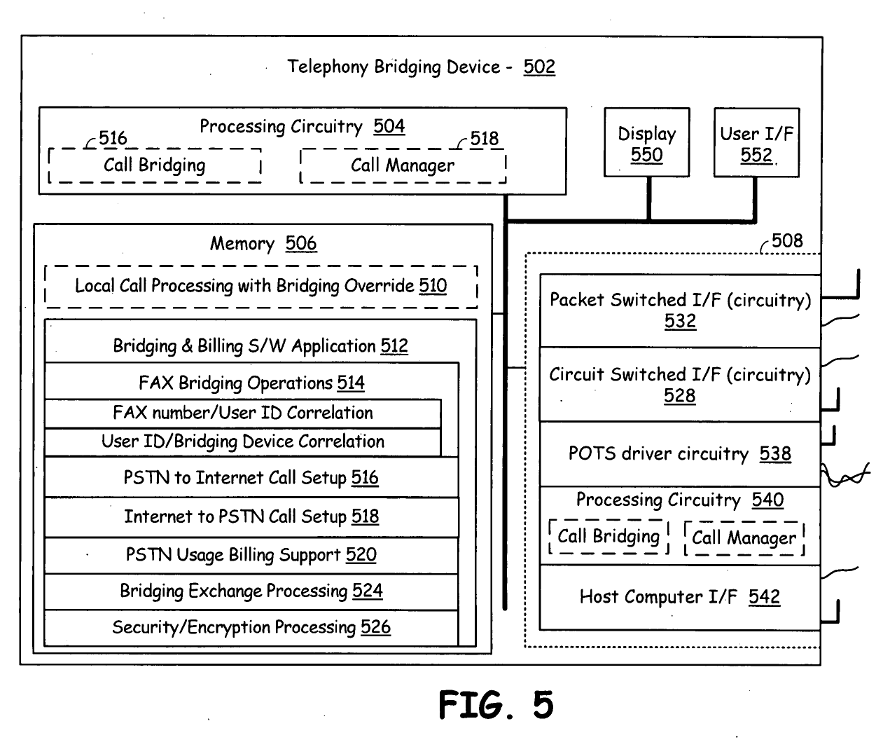

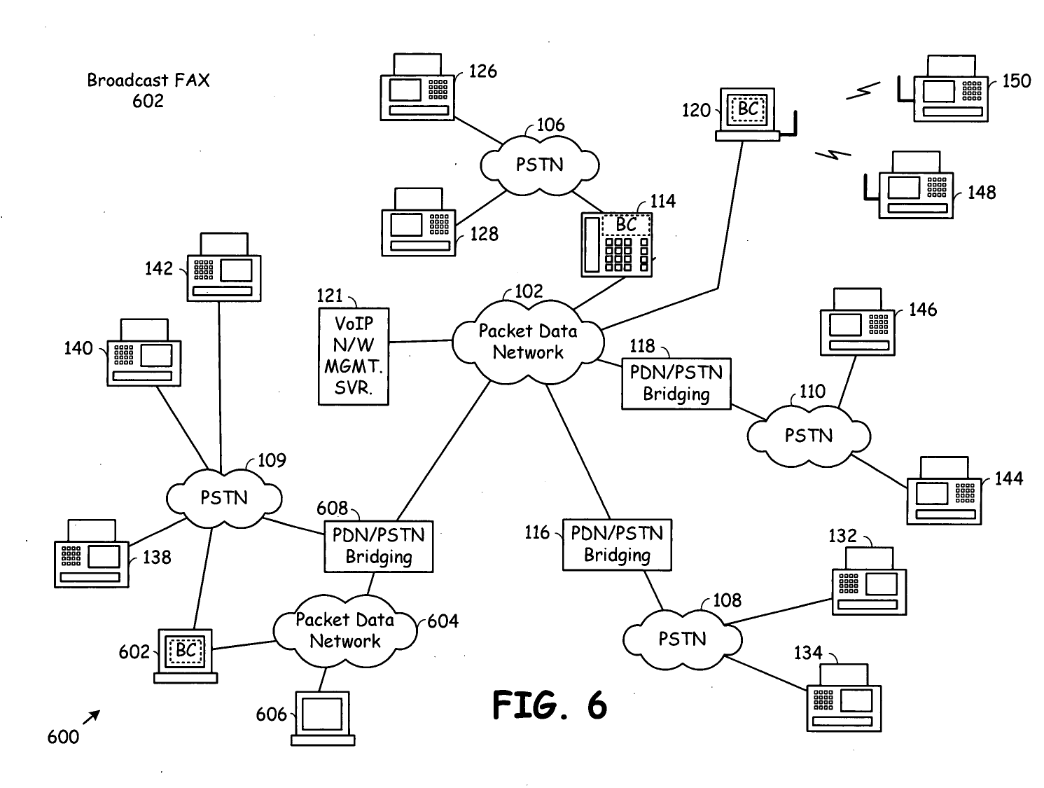

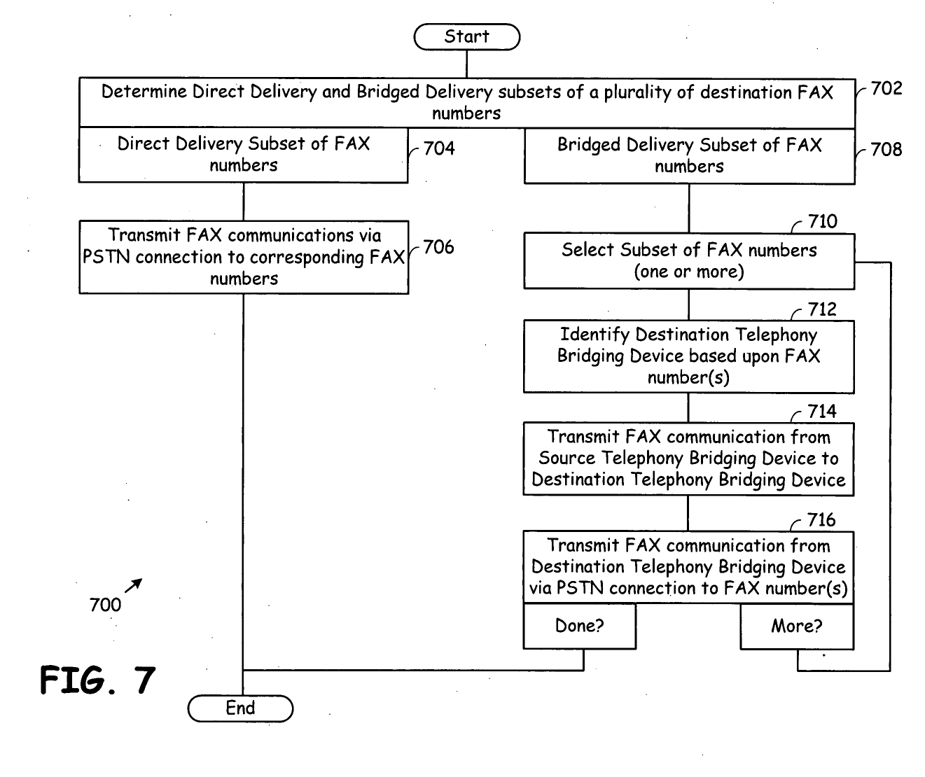

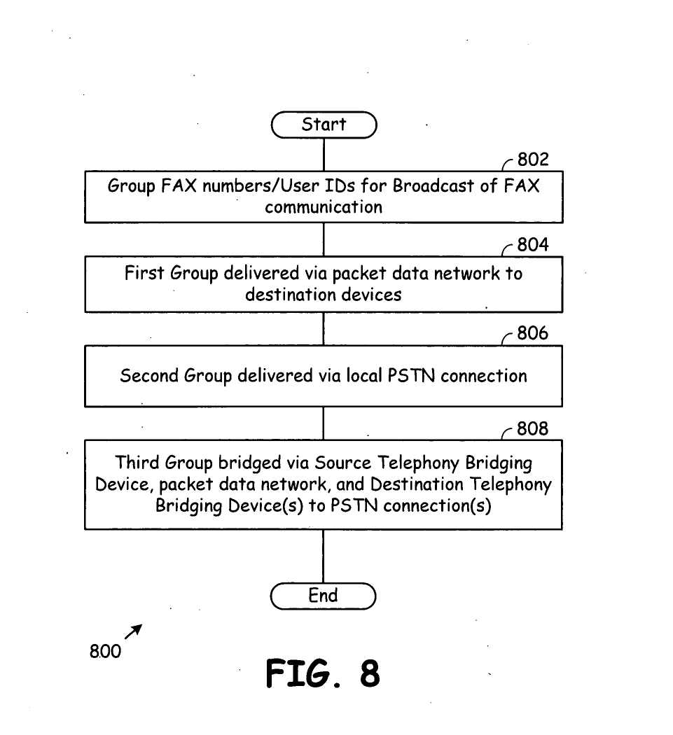

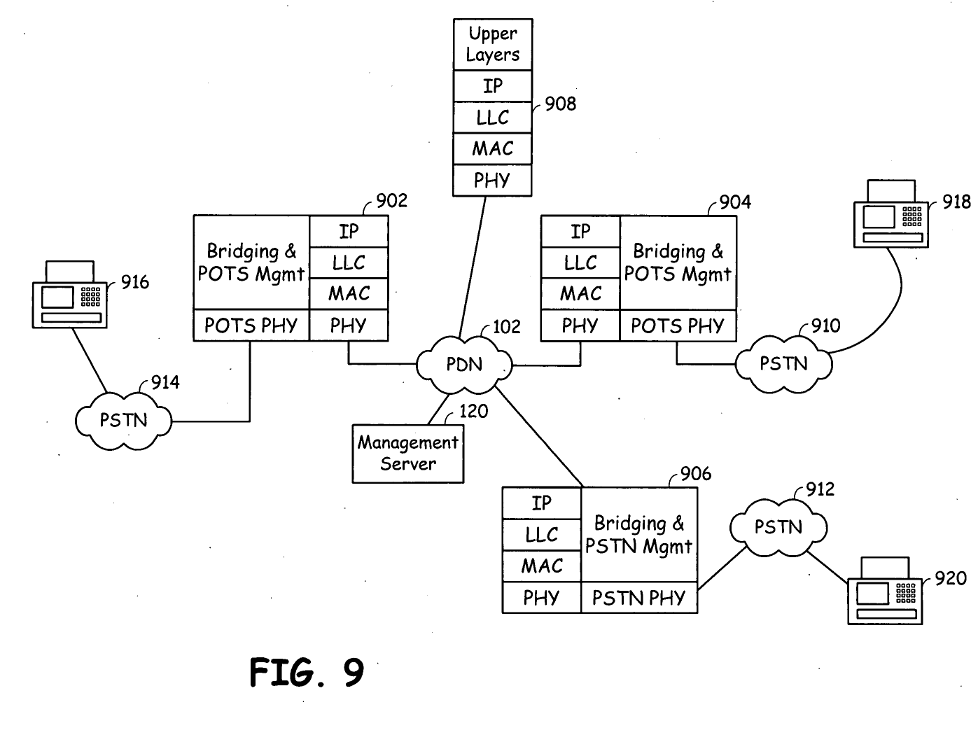

FIG. 5 is a block diagram illustrating a telephony bridging device constructed according to an embodiment of the present invention. The telephony bridging device 502 includes processing circuitry 504, memory 506, interface circuitry 508, a display 550, and a user interface 552. The processing circuitry 504 may be a single processing device or a plurality of processing devices. The processing circuitry 504 may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The memory 506 may be a single memory device, a plurality of memory devices, and/or embedded circuitry of the processing circuitry 504. The memory 506 may be a read-only memory, random access memory, volatile memory, non-volatile memory, static memory, dynamic memory, flash memory, cache memory, and/or any device that stores digital information. Note that when the processing circuitry 504 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory 506, and the processing circuitry 506 executes, hard coded and/or operational instructions corresponding to at least some of the steps and/or functions illustrated in FIGS. 1-15. The display 550 and user interface 552 support local interaction with the telephony bridging device 502 by a user. The display 550 may be employed to display current bridging activity of the telephony bridging device 502.

The interface circuitry 508 includes circuit switched interface circuitry 528, packet switched interface circuitry 532, POTS driver circuitry 538, and may include processing circuitry 540 and/or a host computer interface 542. The circuit switched interface circuitry 528 interfaces the telephony bridging device 502 to the PSTN via one or more wired and/or wireless links. The circuit switched interface circuitry 528 may include a wired link to the PSTN, a wireless link to the PSTN, a wireless link to a cellular network, a fiber optic link to the PSTN, or another circuit switched link. The packet switched interface circuitry 532 interfaces the telephony bridging device 502 to one or more packet switched networks, e.g., the Internet, one or more WANs, one or more LANs, etc., via one or more wired and/or wireless links. The packet switched interface circuitry 532 supports one or more wired packet switched interface standards including Ethernet, for example, and/or other one or more wireless interface standards including any of the IEEE 802.11x interface standards, the WiMAX operating standard, a Digital cable operating standards such as DOCSIS, a satellite communication operating standard, or other wireless interface standards.

The POTS driver circuitry 538 interfaces the telephony bridging device 502 to a POTS telephony device via either a wired or a wireless interface. The POTS driver circuitry 538 generates and delivers POTS signaling to the POTS telephony device. This POTS signaling is equivalent to POTS signaling provided by a Central Office of a PSTN telephone company over twisted pair wiring to a POTS telephone. Such POTS signaling may be provided over a twisted pair of copper conductors or via a wireless connection. In either case, the POTS driver circuitry 538 appears to the POTS telephony device that it is connected directly to a central office of the PSTN. The processing circuitry 504 and/or the processing circuitry 540 of the communication interface 508 is capable of bridging calls between every two of the POTS driver circuitry 538, the circuit switched interface circuitry 528, and the packet switched interface circuitry 532.

The host computer interface 542, when present, interfaces the telephony bridging device 502 to a host computer. The host computer interface 542 may be an expansion card interface, a serial interface, a parallel interface, a wireless interface, or another interface that supports communications between the telephony bridging device 502 and a host computer, e.g., host computer 118 of FIG. 1.

The memory 506 stores software instructions that, when executed by processing circuitry 504 and/or 542, cause the telephony bridging device 502 to operate according to the present invention. Generally, these software instructions support functionality relating to local call processing with bridging override operations 510, bridging and billing software application operations 512, PSTN to Internet call setup operations 516, Internet to PSTN call setup operations 518, PSTN usage billing support operations 520, bridging exchange processing operations 524, and security/encryption processing operations 526. Referring particularly to the local call processing with bridging override instructions 510, upon execution, the processing circuitry 506 and/or 542 enables the telephony bridging device 502 to locally process calls to override bridging operations of the telephony bridging device 502. In its normal operations, the telephony bridging device 502 is available to bridge calls between its packet switched interface circuitry 532 and its circuitry switched interface circuitry 528. However, during such bridging operations, a local subscriber may desire to access the PSTN or the Internet via the POTS driver circuitry 538 and a coupled POTS telephony device that would interrupt or compromise the currently bridged call. The local call processing with bridging override functionality 510 establishes rules that allow the user to access and disrupt a currently bridged call or not depending upon the particular rules established. With the particular operation, a local subscriber (user of POTS telephony device) may always interrupt a currently bridged call, sometimes interrupt a currently bridged call, or never interrupt a currently bridged call. The ability of a local subscriber/user to interrupt a locally bridged call may be based upon access rules that are obtained from a remote location or locally stored.

The bridging and billing software application 512 encompasses each of remote user/device service permissions 514, the PSTN to Internet call setup operations 516, the Internet to PSTN call setup operations 518, the PSTN usage billing support operations 520, the bridging exchange processing operations 524, and the security/encryption processing operations 526. In particular, the remote user/device service permissions operations 514 allow the telephony bridging device 502 to determine whether a remote user or a remote device may use the telephony bridging device 502 for call bridging operations. In such case, when bridging is allowed, these operations 514 allow local, national, and international connections. In other cases, a subset of local, national, and international connections allowed are none of the above, depending upon the permissions of the remote user or remote device.

The PSTN to Internet call setup operations 516 support another PSTN device coupled to the telephony bridging device 502 to setup an Internet call from a calling PSTN terminal. In such case, the PSTN to Internet call setup functions 516 provide audio caller ID functions, touch tone voice mail vectoring operations, or other interface operations that allow a user of a remote PSTN telephone to interact with the telephony bridging device 502. Based upon the communications supported by the PSTN to Internet call setup functionality 516, the remote PSTN user may setup the telephony bridging device 502 for call bridging operations.

The Internet to PSTN call setup operations 518 allow a remote VoIP terminal itself to setup call bridging by the telephony bridging device 502. This functionality may be via a web page interface, a simpler data communication interface that causes exchanges sufficient information to enable the Internet to PSTN call setup to occur, or via another interface.

The PSTN usage and billing support operations 520 allow the telephony bridging device 502 to determine PSTN usage by a non-local subscriber for future billing operations. The PSTN usage billing support operations 520 may interface the telephony bridging device 502 with the billing management software of a service provider server 320. For example, if the telephony bridging device 502 performs call bridging for a remote VoIP or PSTN terminal, the call may be bridged not only to a local PSTN telephone but also to a non-local PSTN telephone wherein additional PSTN tolls are incurred. Any usage of the PSTN while servicing a bridged telephone call may result in PSTN billing to the telephony bridging device 502. The PSTN usage billing support functionality 520 supports capturing of such PSTN usage by the telephony bridging device 502 and subsequent interaction with a server or with another device to cause PSTN usage billing to the appropriate remote subscriber or terminal.

The bridging exchange processing functionality 524 causes the telephony bridging device 502 to track usage of remote subscribers for call bridging operations and to track usage of a local subscriber of remote telephony bridging devices. This functionality may operation in conjunction with a bartering system that tracks usage of various subscribers to the bartering system. In such case, these operations may ensure that usage of telephony bridging devices by differing subscribers is equitable. If the operations are not equitable, the bridging exchange processing operations may cause notification or bills to be sent to a subscriber that uses more than an equitable amount or number of call bridging operations.

The security/encryption processing operations 526 of the telephony bridging device 502 are enacted to: (1) preclude a local user from listening in on bridged calls, and (2) to preclude remote users from listening on communications of a local user of the telephony bridging device 502. Security/encryption processing operations 526 may actually mask or encrypt data communications to preclude the coupled POTS telephony device from eavesdropping on communications that are bridged.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for servicing an incoming Facsimile (FAX) communication comprising:
receiving the incoming FAX communication by a source telephony bridging device via a source PSTN connection, the incoming FAX communication having an incoming FAX number associated therewith;
based upon the incoming FAX number, determining a user ID in a peer-to-peer Voice over Internet Protocol (VoIP) network;
determining an Internet Protocol (IP) address of a destination telephony bridging device based upon the user ID in the peer-to-peer VoIP network;
determining an outgoing FAX number based upon the user ID in the peer-to-peer VoIP network; and
the source telephony bridging device, an intermediate packet data network, and the destination telephony bridging device bridging the FAX communication from the source PSTN connection to a destination PSTN connection, the FAX communication directed to the outgoing FAX number.

2. The method of claim 1, wherein the source PSTN connection is geographically remote from the PSTN connection.

3. The method of claim 1, further comprising:
the source telephony bridging device converting the FAX communication from a PSTN format to a packetized audio format; and
the destination telephony bridging device converting the FAX communication from the packetized audio format to the PSTN format.

4. The method of claim 1, further comprising:
the source telephony bridging device converting the FAX communication from a PSTN format to an image data format; and the destination telephony bridging device converting the FAX communication from the image data format to the PSTN format.

5. The method of claim 1, further comprising:
the source telephony bridging device converting the FAX communication from a PSTN format to an image data format; and
delivering the FAX communication in the image data format to a destination device.

6. The method of claim 1, wherein the source telephony bridging device comprises one of personal computer, a bridging telephone, and a set top box.

7. A method for servicing a plurality of incoming Facsimile (FAX) communications, the method comprising:
by each of a plurality of source telephony bridging devices:
receiving an incoming FAX communication having an incoming FAX number associated therewith at a source PSTN connection;
based upon the incoming FAX number, determining a user ID in a peer-to-peer Voice over Internet Protocol (VoIP) network and an outgoing FAX number of the single destination FAX machine;
determining an Internet Protocol (IP) address of a destination telephony bridging device based upon the user ID of the peer-to-peer VoIP network; and
transmitting the incoming FAX communication to the destination telephony bridging device; and
by the destination telephony bridging device:
receiving the incoming FAX communications from the plurality of source telephony bridging devices, each incoming FAX communication identifying the user ID of the peer-to-peer VoIP network;
identifying a destination FAX number based upon the user ID of the peer-to-peer VoIP network;
receiving the incoming FAX communications from the source telephony bridging device via the at least one servicing packet data network; and
transmitting the FAX communications via a destination PSTN connection to the outgoing FAX number.

8. The method of claim 7, wherein each source PSTN connection is geographically remote from the destination PSTN connection.

9. The method of claim 7, further comprising:
at least one source telephony bridging device converting the FAX communication from a PSTN format to a packetized audio format; and
the destination telephony bridging device converting the FAX communication from the packetized audio format to the PSTN format.

10. The method of claim 7, further comprising:
at least one source telephony bridging device converting the FAX communication from a PSTN format to an image data format; and
the destination telephony bridging device converting the FAX communication from the image data format to the PSTN format.

11. The method of claim 1, further comprising:
at least one source telephony bridging device converting the FAX communication from a PSTN format to an image data format; and
delivering at least one FAX communication in the image data format to a destination device.

12. The method of claim 7, wherein each of the plurality of source telephony bridging devices comprises one of personal computer, a bridging telephone, and a set top box.

13. A method for servicing a broadcast Facsimile (FAX) communication to a plurality of destination FAX machines having corresponding FAX numbers, the method comprising:
determining a direct delivery subset of the plurality of destination FAX numbers and a bridged delivery subset of the plurality of destination FAX numbers; for each corresponding FAX number of the direct delivery subset of the plurality of FAX numbers, transmitting the FAX communication via a direct delivery PSTN connection directed to the corresponding FAX number; for each destination FAX number of the bridged delivery subset of the plurality of FAX numbers:
identifying a destination telephony bridging device based upon the corresponding destination FAX number;
transmitting the FAX communication from the source telephony bridging device to the destination telephony bridging device via a packet data network; and
transmitting the FAX communications from the destination telephony bridging device to the corresponding FAX number via a destination PSTN connection.

14. The method of claim 13, wherein identifying the destination telephony bridging device based upon the corresponding destination FAX number comprises:
determining a user ID in -a peer-to-peer Voice over Internet Protocol (VoIP) network based upon the incoming FAX number; and
determining the destination telephony bridging device based upon the user ID in the peer-to-peer VoIP network.

15. The method of claim 13, further comprising, for at least one destination FAX number of the bridged delivery subset the plurality of FAX numbers:
the source telephony bridging device converting the FAX communication from a PSTN format to a packetized audio format; and
the destination telephony bridging device converting the FAX communication from the packetized audio format to the PSTN format.

16. The method of claim 13, further comprising:
converting the broadcast FAX communication from a PSTN format to an image data format; and
a destination telephony bridging device converting the FAX communication from the image data format to the PSTN format.

17. The method of claim 13, further comprising:
converting the broadcast FAX communication from a PSTN format to an image data format; and
delivering the FAX communication in the image data format to a destination device.

18. The method of claim 14, wherein at least one destination telephony bridging device comprises one of personal computer, a bridging telephone, and a set top box.

19. A telephony bridging device used in a telephony infrastructure including a circuit switched network and the PSTN, the telephony bridging device comprising:
packet switched interface circuitry that supports a call pathway to the packet switched network;
PSTN interface circuitry that supports a call pathway to the PSTN;
processing circuitry coupled to the circuit switched interface circuitry and the PSTN circuitry; and
the processing circuitry operable to:
receive an incoming FAX communication via the circuit switched interface, the incoming FAX communication having an incoming FAX number associated therewith;
based upon the incoming FAX number, determine a user ID in a peer-to-peer Voice over Internet Protocol (VoIP) network;
determine an Internet Protocol (IP) address of a destination telephony bridging device based upon the user ID in the peer-to-peer VoIP network;
determine an outgoing FAX number based upon the user ID in the peer-to-peer VoIP network; and
transmit the FAX communication to the destination telephony bridging device via the packet switched interface, the FAX communication directed to the outgoing FAX number via the destination telephony bridging device.

20. The telephony bridging device of claim 19, wherein the telephony bridging device and the destination telephony bridging device are geographically remote from one another.

21. The telephony bridging device of claim 19, the processing circuitry further operable to:
convert the FAX communication from a PSTN format to a packetized audio format; and
transmit the FAX communication in the image data format to the destination telephony bridging device via the packet data interface in the packetized audio format.

22. The telephony bridging device of claim 19, the processing circuitry further operable to:
convert the FAX communication from a PSTN format to an image data format; and
transmit the FAX communication via the packet data interface in the image data format to the destination telephony bridging device.

23. The telephony bridging device of claim 19, wherein the source telephony bridging device comprises one of personal computer, a bridging telephone, and a set top box.

24. A telephony bridging device used in a telephony infrastructure including a circuit switched network and the PSTN, the telephony bridging device comprising:
packet switched interface circuitry that supports a call pathway to the packet switched network;
PSTN interface circuitry that supports a call pathway to the PSTN;
processing circuitry coupled to the circuit switched interface circuitry and the PSTN circuitry; and
the processing circuitry operable to:
receive a broadcast Facsimile (FAX) communication intended for a plurality of destination FAX machines having corresponding FAX numbers;
determine a direct delivery subset of the plurality of destination FAX numbers and a bridged delivery subset of the plurality of destination FAX numbers;
for each corresponding FAX number of the direct delivery subset of the plurality of FAX numbers, transmit the FAX communication via the PSTN interface circuitry directed to the corresponding FAX number;
for each destination FAX number of the bridged delivery subset the plurality of FAX numbers:
identify a destination telephony bridging device based upon the corresponding destination FAX number;
transmit the FAX communication to the destination telephony bridging device via the packet switched interface circuitry along with the corresponding FAX number.

25. The telephony bridging device of claim 24, wherein in identifying the destination telephony bridging device based upon the corresponding destination FAX, the processing circuitry is operable to:
determine a user ID in a peer-to-peer Voice over Internet Protocol (VoIP) network based upon the incoming FAX number; and
determine the destination telephony bridging device based upon the user ID in the peer-to-peer VoIP network.

26. The telephony bridging device of claim 24, the processing circuitry further operable to:
convert the FAX communication from a PSTN format to a packetized audio format; and
transmit the FAX communication in the image data format to the destination telephony bridging device via the packet data interface in the packetized audio format.

27. The telephony bridging device of claim 24, the processing circuitry further operable to:
convert the FAX communication from a PSTN format to an image data format; and
transmit the FAX communication via the packet data interface in the image data format to the destination telephony bridging device.

28. The telephony bridging device of claim 24, wherein the source telephony bridging device comprises one of personal computer, a bridging telephone, and a set top box.
